(19) United States
(12) Patent Application Publication
(10) Pub. No.: US 2025/0360760 A1
(43) Pub. Date: Nov. 27, 2025

(54) RUNFLAT ASSEMBLY

(71) Applicant: TYRON INTERNATIONAL LIMITED, JERSEY (GB)

(72) Inventor: Richard GLAZEBROOK, Channel Islands (GB)

(21) Appl. No.: 18/873,433

(22) PCT Filed: Jun. 9, 2023
(86) PCT No.: PCT/GB2023/051510

§ 371 Date: Dec. 10, 2024

(30) Foreign Application Priority Data
Jun. 10, 2022 (GB) 2208523.7

(51) Int. Cl. B60C 17/04

(52) U.S. Cl. CPC B60C 17/041

(57) ABSTRACT

A runflat assembly comprises a plurality of circumferentially extending section parts interconnectable together into an annular configuration to fit around a wheel, the runflat assembly including a connector member configured to interconnect two of the circumferentially extending section parts, the runflat assembly including a retraction mechanism operable to act on the connector member to selectively permit the two circumferentially extending section parts to be spaced apart from each other in a first configuration of the connector member and draw the two circumferentially extending section parts towards each other in a second configuration of the connector member, wherein the connector member is configured to be releasable from at least one of the two circumferentially extending section parts.

### CROSS-REFERENCE TO RELATED APPLICATIONS

This application is a U.S. national phase application filed under 35 U.S.C. § 371 of International Application Number PCT/GB2023/051510, filed Jun. 9, 2023, designating the United States, which claims priority from United Kingdom Patent Application Number GB 2208523.7, filed Jun. 10, 2022, both of which are hereby incorporated by reference herein in their entireties.

### FIELD

This disclosure relates to a runflat assembly and to a wheel assembly comprising a runflat assembly.

### BACKGROUND

In a number of instances, runflat assemblies are provided for vehicle wheels. Such assemblies generally comprise an annular ring that fits around a wheel inside of the tyre. This provides a ground engaging surface around the wheel, upon which surface a vehicle can run in the event of deflation of a tyre.

### SUMMARY

According to an aspect of this disclosure, there is provided a runflat assembly comprising a plurality of circumferentially extending section parts interconnectable together into an annular configuration to fit around a wheel, the runflat assembly including a connector member configured to interconnect two of the circumferentially extending section parts, the runflat assembly including a retraction mechanism operable to act on the connector member to selectively permit the two circumferentially extending section parts to be spaced apart from each other in a first configuration of the connector member and draw the two circumferentially extending section parts towards each other in a second configuration of the connector member, wherein the connector member is configured to be releasable from at least one of the two circumferentially extending section parts.

During use of the runflat assembly, it may be necessary to fix or replace the connector member or to disconnect the circumferentially extending section parts. This is readily facilitated by the ability of the runflat assembly to release the connector member from either or both of the two circumferentially extending section parts. In contrast, in conventional runflat assemblies that can be pre-assembled before being installed into the tyre, the integration of the connector member into the circumferentially extending section parts is such that the connector member cannot be removed without destroying the connector member, the circumferentially extending section parts or both, which increases wastage and costs.

In a preferred embodiment of this disclosure, the connector member may be a flexible connector member such as a cable. The connector member may be made of, but is not limited to, carbon fibre or a carbon fibre composite.

In embodiments of this disclosure, the runflat assembly may include a longitudinal securing member (such as a bolt) extending through a first of the two circumferentially extending section parts. The longitudinal securing member may be configured to secure a first part (e.g. a first end) of the connector member in the first circumferentially extending section part. For example, the first part of the connector member may be looped around the longitudinal securing member so as to secure the first part of the connector member in the first circumferentially extending section part. The longitudinal securing member may be configured to be removable to permit release of the first part of the connector member from the first circumferentially extending section part.

The provision of the longitudinal securing member provides a reliable means of securing the connector member to the first circumferentially extending section part while providing the ability to release the first part of the connector member from the first circumferentially extending section part when needed. For example, the longitudinal securing member can be removed by pushing or pulling it through the first circumferentially extending section part.

The runflat assembly may include a circlip arranged to removably secure the longitudinal securing member to the first circumferentially extending section part. The circlip provides a reliable means for securing the longitudinal securing member while allowing quick removal of the longitudinal securing member from the first circumferentially extending section part.

In particular, an inner segment of the circlip may include a notch that is arranged to be adjacent to the longitudinal securing member. The presence of such a notch enables the circlip to be opened by using a tool, such as a screwdriver, to engage the notch and thereby open the circlip. This is especially useful in situations in which access to the circlip is limited.

The longitudinal securing member may be a securing pin. Preferably the securing pin has a threaded portion, onto which a nut may be fastened to removably secure the longitudinal securing member to the first circumferentially extending section part. The threaded securing pin provides another reliable means for securing the longitudinal securing member while allowing quick removal of the longitudinal securing member from the first circumferentially extending section part.

Optionally the longitudinal securing member may be operable using an Allen key (or hex key), such as a ball-ended Allen key. The use of the Allen key provides a user with more room to access and operate the longitudinal securing member, especially when the wheel has a low-profile tyre. In particular, the ball-ended Allen key enables the user to access and operate the longitudinal securing member from different angles.

In further embodiments of this disclosure, the runflat assembly may include a cassette arranged in a second of the two circumferentially extending section parts. The retraction mechanism may be arranged in the cassette. A second part (e.g. a second end) of the connector member may be attached to the retraction mechanism. The cassette may be configured to be removable from the second circumferentially extending section part. Preferably the retention mechanism is housed in the cassette.

In addition to providing a way for releasing the connector member from the corresponding circumferentially extending section part(s), the cassette provides protection for the retention mechanism and the second part of the connector member so as to prevent the second part of the connector member from being trapped inside the second circumferentially extending section part.

In such embodiments, the cassette may be configured to be removably push fitted in the second circumferentially extending section part. The push fit ensures that the cassette is reliably secured in the second circumferentially extending section part while permitting easy removal and replacement of the cassette from the second circumferentially extending section part upon application of a suitable force. In addition the push fit removes the need for any fasteners or fixtures to secure the cassette in the second circumferentially extending section part.

Different types of mechanisms may be used as the retraction mechanism as long as it can be operated to selectively permit the two circumferentially extending section parts to be spaced apart from each other in a first configuration of the connector member and draw the two circumferentially extending section parts towards each other in a second configuration of the connector member. Preferably the retraction mechanism is a ratchet mechanism.

Preferably the runflat assembly includes a plurality of connector members, each connector member configured to interconnect two of the circumferentially extending section parts, wherein each connector member is configured to be selectively releasable from at least one of the corresponding two circumferentially extending section parts.

In embodiments of this disclosure, at least one of the circumferentially extending section parts may include a body and at least one wing. The or each wing may extend away from the body in a direction that is parallel or substantially parallel to a rotational axis of the runflat assembly.

The provision of the or each wing prevents the risk of the runflat assembly sliding into the base of a well of a wheel. Otherwise allowing the runflat assembly to slide into the base of the well would result in the runflat assembly becoming loose, which not only negatively affects the balance of the wheel but also allows the runflat assembly to freely rotate during acceleration and braking which will damage the valve and may damage or break one or more parts of the runflat assembly and the wheel. In addition, if the runflat assembly is tightened around the wheel while installed in the base of the well, access to the well is restricted, thus making it difficult to re-fit a tyre around the wheel.

Optionally the or each wing may be connected to the body along part of a circumferential length of the corresponding circumferentially extending section part. Further optionally the or each wing may be connected to the body at or adjacent to a circumferential end of the corresponding circumferentially extending section part.

Preferably the or each wing is made of a resilient material, such as an elastomer or rubber.

According to another aspect of this disclosure, there is provided a runflat assembly comprising a plurality of circumferentially extending section parts interconnectable together into an annular configuration to fit around a wheel, at least one of the circumferentially extending section parts including a body and at least one wing, the or each wing extending away from the body in a direction that is parallel or substantially parallel to a rotational axis of the runflat assembly. Optionally the or each wing may be connected to the body along part of a circumferential length of the corresponding circumferentially extending section part. Further optionally the or each wing may be connected to the body at or adjacent to a circumferential end of the corresponding circumferentially extending section part. Preferably the or each wing is made of a resilient material, such as an elastomer or rubber.

Aspects and embodiments of this disclosure may also extend to a wheel assembly comprising a wheel, a runflat assembly as described hereinabove mounted around the wheel, and a tyre mounted around the runflat assembly. Optionally the tyre may be mounted around the runflat assembly so that an interior surface of the tyre engages with the runflat assembly.

The runflat assembly may comprise two section parts or three section parts. The runflat assembly may comprise any number of multiple section parts, such as four, five, six or more. Preferably each circumferentially extending section part is an arcuate section part. The number of connector members may be selected to provide interconnection between some or all of the section parts.

It will be appreciated that the use of the terms “first” and “second”, and the like, in this patent specification is merely intended to help distinguish between similar features, and is not intended to indicate the relative importance of one feature over another feature, unless otherwise specified.

Within the scope of this application it is expressly intended that the various aspects, embodiments, examples and alternatives set out in the preceding paragraphs, and the claims and/or the following description and drawings, and in particular the individual features thereof, may be taken independently or in any combination. That is, all embodiments and all features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Preferred embodiments will now be described, by way of non-limiting examples, with reference to the accompanying drawings in which:

FIGS. 1 to 3 respectively show side, cross-sectional and perspective views of a runflat assembly according to an embodiment;

FIG. 4 shows a section part of the runflat assembly of FIG. 1;

FIG. 5a shows a support member of the runflat assembly of FIG. 1;

FIG. 5b shows another support member of the runflat assembly of FIG. 1;

FIGS. 6 to 8 show a bolt and circlip arrangement for securing a connector member to a section part;

FIGS. 9 to 11 show a cassette of the runflat assembly of FIG. 1;

FIG. 12 shows a bolt for securing a connector member to a section part; and

FIGS. 13 to 16 show a locking member of the runflat assembly of FIG. 1.

The figures are not necessarily to scale, and certain features and certain views of the figures may be shown exaggerated in scale or in schematic form in the interests of clarity and conciseness.

### DETAILED DESCRIPTION

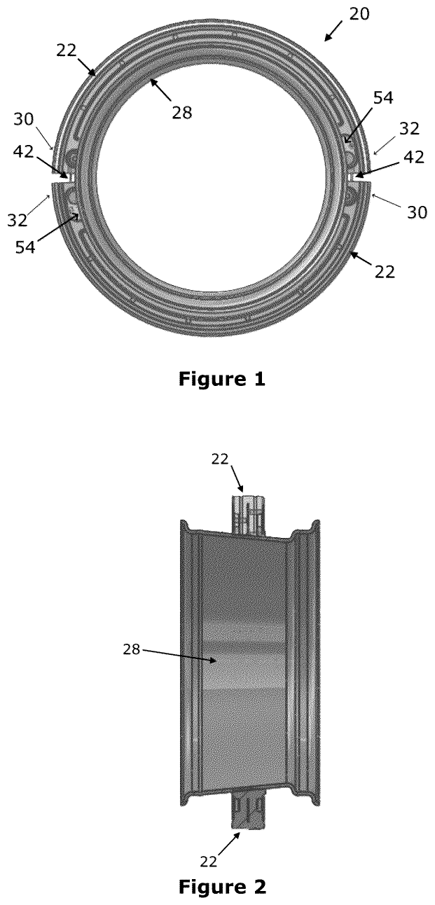

A runflat assembly according to a first embodiment is shown in FIGS. 1 to 3 and is designated generally by the reference numeral 20.

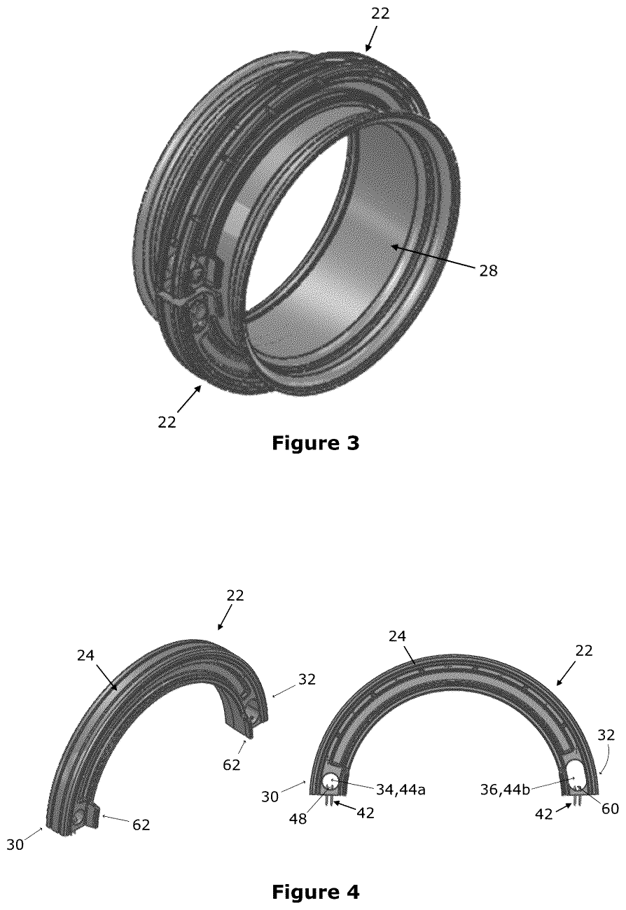

The runflat assembly 20 comprises two interconnectable circumferentially extending section parts 22. Each section part 22 includes a rubber body 24. Located within the body 24 is a steel support member 26. In FIGS. 1 and 3, a portion of the section part 22 is cut out for illustrative purposes to show the internal support member 26. It will be appreciated that the support member 26 may be made of a different material and that the support member 26 is optional.

Each section part 22 defines a 180° arc (or a substantially 180° arc). The bodies 24 of the interconnected section parts 22 together define a generally annular configuration with an external circumferential surface and an internal circumferential surface. In use, the interconnected section parts 22 are located on a wheel body 28, and a tyre (not shown) would fit on the wheel body 28 around the runflat assembly 20, with edges of the tyre engaging with the wheel rims.

The support member 26 is in the form of an arcuate beam, which is preferably located wholly within the body 24, with radial ends of the beam spaced respectively from the external and internal circumferential surfaces.

The provision of multiple section parts 22 interconnected together in an annular configuration also allows a user to tighten or loosen the runflat assembly 20 while it is on the wheel. This can facilitate location of a tyre on the wheel and removal of a tyre from the wheel.

It is envisaged that, in other embodiments, the body 24 may be made of a different resilient material, such as a different elastomer.

The body 24 and/or the support member 26 may have a different shape. The size and/or shape of the runflat assembly 20 will depend on the size of tyre fitted to the vehicle.

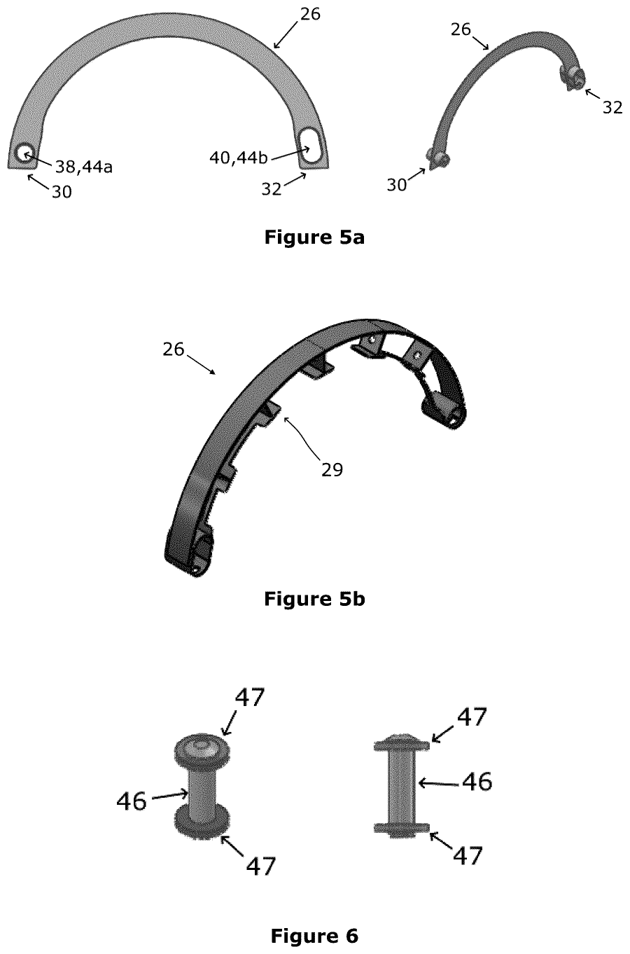

FIGS. 4, 5a and 5b show the section part 22 and the support member 26 of the runflat assembly 20. The support member 26 may be made of a solid piece as shown in FIG. 5a. Alternatively, in other embodiments, the support member 26 may shaped as a frame with one or more hollow sections as shown in FIG. 5b. An inner perimeter 29 of the support member 26 may be continuous or discontinuous.

The body 24 of each section part 22 includes, at each free end 30,32 of the section part 22, first and second holes 34,36. Each support member 26 includes, at each free end 30,32 of the section part 22, first and second holes 38,40 that are respectively aligned with the first and second holes 34,36 of the corresponding body 24 so that different support members 26 are also interconnected in an annular configuration when the corresponding section parts 22 are interconnected in the annular configuration.

The runflat assembly 20 further includes two connector members 42. Each connector member 42 is in the form of a pair of cables but it is envisaged that each connector member may take the form of a single cable and that other flexible connector members may be used. Each connector member 42 is preferably made from carbon fibre or a carbon fibre composite. Each connector member 42 is configured to interconnect the free ends 30,32 of the section parts 22 so that first and second free ends 30,32 of one section part 22 are respectively connected to second and first free ends 32,30 of the other section part 22.

The first holes 34,38 of the body 24 and support member 26 define a first opening 44a at the first free end 30 of the section part 22 for receiving a longitudinal securing member in the form of a bolt 46. The bolt 46 is shown in FIG. 6 and is preferably a stainless steel bolt. The first opening 44a is circular in shape in the embodiment shown but may have other shapes in other embodiments. Discs 47 are provided at each end of the bolt. The discs 47 are sized and shaped to close off both sides of the first opening 44a when the bolt 46 is inserted into the first opening 44a.

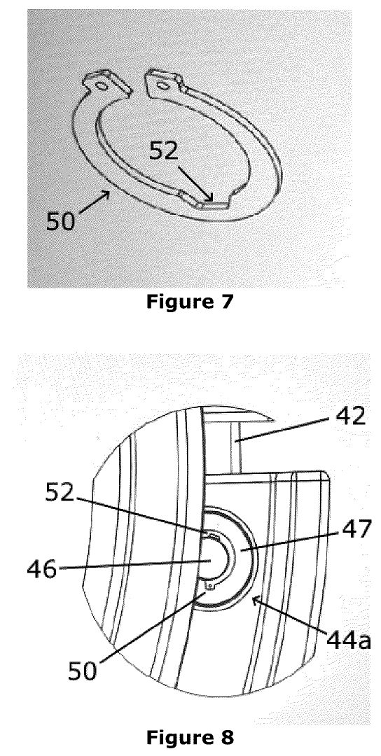

A first end 48 of the connector member 42 extends through a hole in the cross-sectional face of the first free end 30 of the section part 22 so that the first end 48 of the connector member 42 is accessible through the first opening 44a. The bolt 46 is then inserted into one side of the first opening 44a to extend through the first free end 30 of the section part 22 so that the first end 48 of the connector member 42 is looped around or otherwise secured to the bolt 46. This helps to secure the first end 48 of the connector member 42 in the section part 22. A circlip 50 shown in FIG. 7 is then attached around the bolt 46 at the opposite, second side of the first opening 44a to secure the bolt 46 to the section part 22, as shown in FIG. 8. An inner segment of the circlip includes a notch 52 that is arranged to be adjacent to the bolt 46.

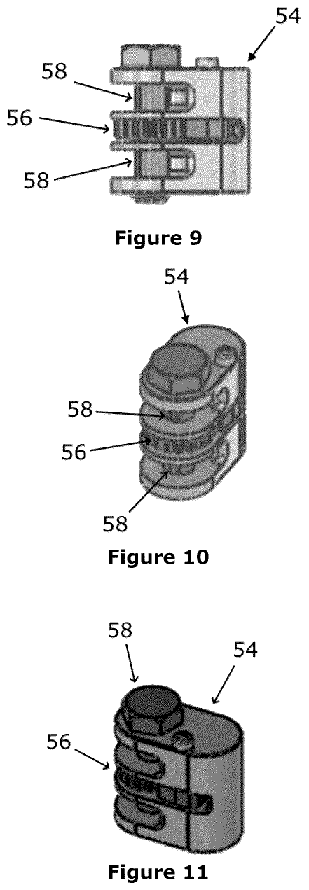

The second holes 36,40 of the body 24 and support member 26 define a second opening 44b at the second free end 32 of the section part 22 for receiving a cassette 54. FIGS. 9 to 11 show the cassette 54. The second opening 44b is oblong in shape in the embodiment shown but may have other shapes in other embodiments. The cassette 54 is similarly oblong shaped so that it can be push fitted in the second opening 44b. The cassette 54 is removable from the second opening 44b upon application of a suitable pushing force. The cassette 54 may be made from carbon fibre or a carbon fibre composite.

The cassette 54 includes a retraction mechanism in the form of a ratchet mechanism that comprises a gear 56, a pawl and a pin 58. The gear 56 and pawl are configured to be operable to provide a ratchet function. The pawl is operable to release the gear 56. The ratchet mechanism is housed in the cassette 54 and receptacles are formed in the cassette 54 so that the ratchet mechanism is flanked by the receptacles on both sides of the ratchet mechanism. A pin 58 extends though the cassette 54 so that it passes through one receptacle, the gear 56 and the other receptacle. Thus, the gear 56 is rotatable together with the pin 58.

A second end 60 of the connector member 42 is attached to the pin 58 in the receptacles. Specifically, each cable of the connector member 42 is attached to the pin 58 in a respective one of the receptacles. Alternatively, if the connector member 42 comprises one cable, then the cable may be attached to the pin 58 in one of the two receptacles. Such attachment of the connector member's second end 60 to the pin 58 may be carried out by looping or winding the cables around the pin 58, by tying knots, by using a fastener or by providing holes (such as threaded holes) in the pin 58 for inserting the cables.

The second end 60 of the connector member 42 extends through a hole in the cross-sectional face of the second free end 32 of the section part 22. The second end 60 of the connector member 42 may be pre-wound around the pin 58 before the cassette 54 is push fitted into the second opening 44b and the second end 60 of the connector member 42 is pulled through the hole in the cross-sectional face of the second free end 32 of the section part 22. Alternatively the cassette 54 may be push fitted into the second opening 44b before the second end 60 of the connector member 42 is inserted into the hole in the cross-sectional face of the second free end 32 of the section part 22 and then the second end 60 of the connector member 42 is attached to the pin 58.

In this way the connector members 42 are configured to interconnect the free ends 30,32 of the section parts 22 so that: .
the ratchet mechanism is operable by rotating the pin 58 to wind the cables around the pin 58 to draw the section parts 22 together in order to form the annular configuration of the section parts 22; and.
the ratchet mechanism is operable by releasing the gear 56 to allow the cables to be unwound and thereby permit the sections parts to be separated and spaced apart from each other.

Under certain circumstances, it may be necessary to fix or replace the connector member 42 or to disconnect the circumferentially extending section parts 22. However it is not desirable to cut the connector members 42 or destroy the section parts 22 in order to release the connector members 42 from the section parts 22.

Each bolt 46 may be removed from the corresponding section part 22 by using a tool, such as a flat head screwdriver, to engage the notch 52 of the circlip 50 in order to force the circlip 50 to open and release the bolt 46. The bolt 46 is then removed from the section part 22 by pushing or pulling. By removing the bolt 46 from the section part 22, the first end 48 of the connector member 42 can be pulled out of the first free end 30 of the section part 22. In this regard the circlip 50 is positioned at the side of the section part 22 that is accessible by a user.

The second end 60 of the connector member 42 may be detached from the pin 58 and therefore detached from the cassette 54, which is then removed from the section part 22 by pushing it out of the second opening 44b. Alternatively the ratchet mechanism may be operated to wind the connector member 42 around the pin 58 before the cassette 54 is removed from the section part 22.

In this way the connector members 42 are configured to be releasable from the section parts 22 of the runflat assembly 20. In addition, the cassette 54 provides protection for the ratchet mechanism and the connector member 42 to prevent jamming of the connector member 42 inside the section part 22 during use of the runflat assembly 20.

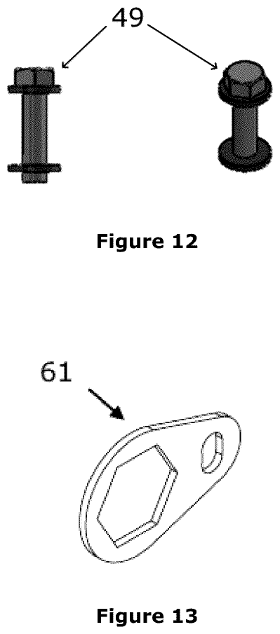

In alternative embodiments, the longitudinal securing member may be in the form of a threaded bolt 49, an example of which is shown in FIG. 12. This beneficially removes the need for the circlip 50 and makes it simpler for a user to screw and unscrew the bolt 49 as needed.

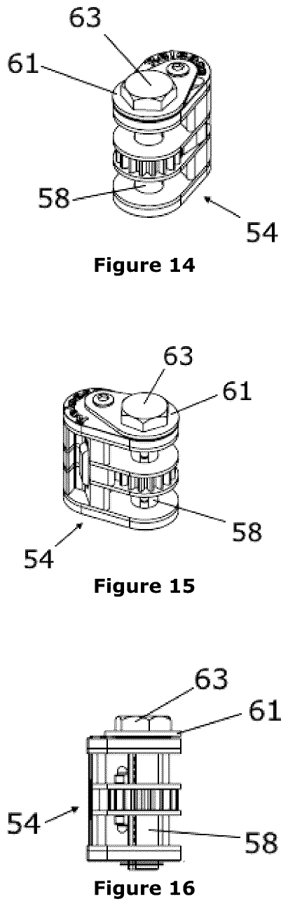

FIGS. 13 to 16 show an optional locking member 61 that forms part of the runflat assembly 20. The locking member 61 is secured to the side of the cassette 54, and includes an aperture that locks the pin 58 in place to prevent it from loosening itself from the cassette 54. For example, in FIGS. 14 to 16, the aperture has a hexagonal shape that matches the hexagonal shape of the bolt head 63 so that, when the aperture is placed around the bolt head, the pin 58 is prevented from rotating which in turn prevents it from loosening itself from the cassette 54. This provides additional assurance that the pin 58 is properly secured in the cassette 54 when the runflat assembly 20 is on the wheel.

Optionally, as shown in FIG. 4, at least one of the section parts 22 may include wings 62 that extend away from the body 24 in a direction that is parallel or substantially parallel to a rotational axis of the runflat assembly 20. Preferably the wings 62 are connected to the body 24 at or adjacent to the free ends 30,32 of the section parts 22, and are connected to the body 24 along part of a circumferential length of the section parts 22. Additionally or alternatively one or more wings 62 may be connected to the body 24 at an intermediate location between the free ends 30,32 of the section parts 22, and are connected to the body 24 along part of a circumferential length of the section parts 22. The wings 62 may be made of a resilient material, such as the same material as the body 24. In use, the wings 62 extend into a well of a wheel, and engage the well, to prevent the body 24 of the runflat assembly 20 from sliding into the base of the well.

In other embodiments, the longitudinal securing member may be a securing pin with a threaded portion, onto which a nut may be fastened to removably secure the longitudinal securing member to the first circumferentially extending section part 22. Optionally the longitudinal securing member may be operable using a ball-ended Allen key, which enables the user to access and operate the longitudinal securing member from different angles. This is especially useful when the wheel has a low-profile tyre.

It will be appreciated that the number of section parts in a given runflat assembly may vary. For example, a runflat assembly may be provided with only two section parts, particularly for use with smaller wheels. For very large wheels, it may be that at least three section parts are required. It will also be appreciated that the runflat assembly may comprise any number of multiple section parts, such as four, five, six or more.

The listing or discussion of an apparently prior-published document or apparently prior-published information in this specification should not necessarily be taken as an acknowledgement that the document or information is part of the state of the art or is common general knowledge.

Preferences and options for a given aspect, feature or parameter of the invention should, unless the context indicates otherwise, be regarded as having been disclosed in combination with any and all preferences and options for all other aspects, features and parameters of the invention.

1. A runflat assembly comprising a plurality of circumferentially extending section parts interconnectable together into an annular configuration to fit around a wheel, the runflat assembly including a connector member configured to interconnect two of the circumferentially extending section parts, the runflat assembly including a retraction mechanism operable to act on the connector member to selectively permit the two circumferentially extending section parts to be spaced apart from each other in a first configuration of the connector member and draw the two circumferentially extending section parts towards each other in a second configuration of the connector member, wherein the connector member is configured to be releasable from at least one of the two circumferentially extending section parts.

2. A runflat assembly according to claim 1 wherein the connector member is a flexible connector member.

3. A runflat assembly according to claim 2 wherein the flexible connector member is a cable.

4. A runflat assembly according to claim 1 wherein the connector member is made of carbon fibre or a carbon fibre composite.

5. A runflat assembly according to claim 1 including a longitudinal securing member extending through a first of the two circumferentially extending section parts, wherein the longitudinal securing member is configured to secure a first part of the connector member in the first circumferentially extending section part, wherein the longitudinal securing member is configured to be removable to permit release of the first part of the connector member from the first circumferentially extending section part.

6. A runflat assembly according to claim 5 wherein the first part of the connector member is looped around the longitudinal securing member so as to secure the first part of the connector member in the first circumferentially extending section part.

7. A runflat assembly according to claim 5 including a circlip arranged to removably secure the longitudinal securing member to the first circumferentially extending section part.

8. A runflat assembly according to claim 7 wherein an inner segment of the circlip includes a notch that is arranged to be adjacent to the longitudinal securing member.

9. A runflat assembly according to claim 1 including a cassette arranged in a second of the two circumferentially extending section parts, the retraction mechanism arranged in the cassette, a second part of the connector member attached to the retraction mechanism, wherein the cassette is configured to be removable from the second circumferentially extending section part.

10. A runflat assembly according to claim 9 wherein the cassette is configured to be removably push fitted in the second circumferentially extending section part.

11. A runflat assembly according to claim 1 wherein the retraction mechanism is a ratchet mechanism.

12. A runflat assembly according to claim 1 including a plurality of connector members, each connector member configured to interconnect two of the circumferentially extending section parts, wherein each connector member is configured to be selectively releasable from at least one of the corresponding two circumferentially extending section parts.

13. A runflat assembly according to claim 1 wherein at least one of the circumferentially extending section parts includes a body and at least one wing, the or each wing extending away from the body in a direction that is parallel or substantially parallel to a rotational axis of the runflat assembly.

14. A runflat assembly according to claim 13 wherein the or each wing is connected to the body along part of a circumferential length of the corresponding circumfrentially extending section part.

15. A runflat assembly according to claim 13 wherein the or each wing is connected to the body at or adjacent to a circumferential end of the corresponding circumferentially extending section part.

16. A runflat assembly according to claim 13 wherein the or each wing is made of a resilient material.

17. A wheel assembly comprising a wheel, a runflat assembly according to claim 1 mounted around the wheel, and a tyre mounted around the runflat assembly.

18. A wheel assembly according to claim 17, wherein at least one of the circumferentially extending section parts includes a body and at least one wing, the or each wing extending away from the body in a direction that is parallel or substantially parallel to a rotational axis of the runflat assembly, and wherein the or each wing extend into a well of the wheel.
